(19) United States
(12) Patent Application Publication
(10) Pub. No.: US 2025/0188213 A1
(43) Pub. Date: Jun. 12, 2025

(54) VINYL GROUP-CONTAINING PHOSPHORIC COPOLYMER, RESIN COMPOSITION AND ARTICLE MADE THEREFROM

(71) Applicant: Elite Material Co., Ltd., Taoyuan City (TW)

(72) Inventor: Chen-Yu HSIEH, Taoyuan City (TW)

(21) Appl. No.: 18/585,863

(22) Filed: Feb. 23, 2024

Related U.S. Application Data
(60) Provisional application No. 63/606,705, filed on Dec. 6, 2023.

(51) Int. Cl. C08F 230/02; C08J 5/24; C08L 71/12; C08L 85/02

(52) U.S. Cl. CPC C08F 230/02; C08J 5/24; C08L 71/126; C08L 85/02; C08J 2343/02; C08J 2371/12; C08J 2443/02; C08J 2471/12

(57) ABSTRACT

A vinyl group-containing phosphoric copolymer, a resin composition comprising the phosphoric copolymer and an article made from the resin composition are disclosed. The vinyl group-containing phosphoric copolymer includes a structural unit of Formula (1-1) and a structural unit of Formula (1-2). The resin composition includes 100 parts by weight of a vinyl group-containing polyphenylene ether resin and 55 to 80 parts by weight of a vinyl group-containing phosphoric copolymer. The resin composition may be used to make a prepreg, a resin film, a laminate or a printed circuit board, and at least one of the following properties can be improved, including dielectric constant, dissipation factor, copper foil peeling strength, flame retardancy, glass transition temperature and PCT water absorption ratio.

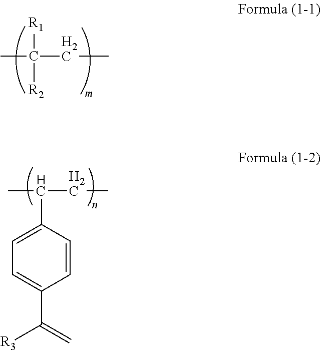

### CROSS-REFERENCE TO RELATED APPLICATION

This application claims the priority benefits of U.S. provisional application No. 63/606,705, filed on Dec. 6, 2023. The entirety of the above-mentioned patent application is hereby incorporated by reference herein and made a part of this specification.

### BACKGROUND

### 1. Field of the Disclosure

The present disclosure pertains to the technical field of polymer materials and more particularly to a vinyl group-containing phosphoric copolymer, a resin composition comprising the phosphoric copolymer and an article made from the resin composition.

### 2. Description of Related Art

In recent years, due to the development of electronic signal transmission toward 5G and the trend of miniaturization and high performance of electronic equipment, communication devices and personal computers, circuit boards were also developed toward multi-layer configuration, high density trace interconnection, and high speed signal transmission, thereby presenting higher challenges to the overall performance of circuit laminates such as copper-clad laminates.

In order to improve the overall performance of a circuit laminate, prior arts primarily focus on adjusting the type, amount or ratio of the components of raw material resin compositions. However, an article made from conventional resin materials such as a laminate still fails to fully meet the demands in properties.

### SUMMARY

To overcome the problems of prior arts, particularly one or more property demands facing conventional materials, it is a primary object of the present disclosure to provide a novel resin material which may overcome at least one of the above-mentioned technical problems.

To achieve the above-mentioned objects, the present disclosure provides a vinyl group-containing phosphoric copolymer, which comprises a structural unit of Formula (1-1) and a structural unit of Formula (1-2),

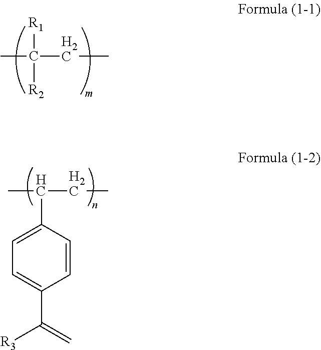

wherein:
m and n independently represent a repeating number of unit in the brackets by which the vinyl group-containing phosphoric copolymer has a weight average molecular weight of between 1,000 and 50,000;
R₁ and R₃ are independently a hydrogen atom or a C₁ to C₃ alkyl group; and
R₂ is a monovalent functional group selected from a group consisting of Formula (1-3) to Formula (1-8), wherein r and q are independently an integer of 0 to 3;

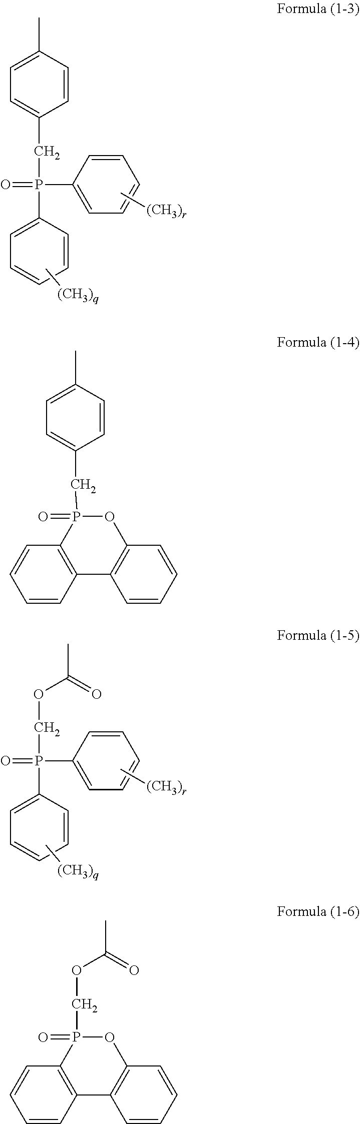

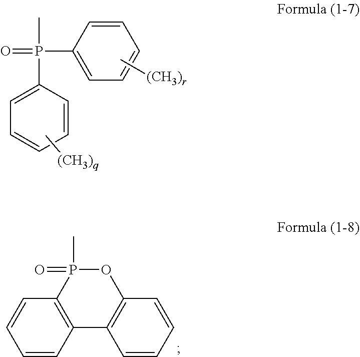

and the vinyl group-containing phosphoric copolymer has a phosphorus content of greater than or equal to 7%.

In addition, the present disclosure also provides a resin composition, comprising 100 parts by weight of a vinyl group-containing polyphenylene ether resin and 55 to 80 parts by weight of a vinyl group-containing phosphoric copolymer.

For example, in one embodiment, the resin composition further comprises a multi-functional aromatic vinyl group-containing compound.

For example, in one embodiment, the resin composition further comprises 5 to 25 parts by weight of a multi-functional aromatic vinyl group-containing compound.

For example, in one embodiment, the multi-functional aromatic vinyl group-containing compound has a structure of Formula (2):

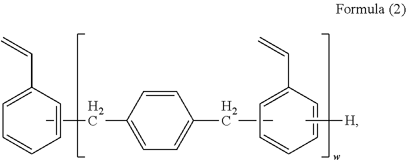

wherein w is between 1 and 20.

For example, in one embodiment, the vinyl group-containing phosphoric copolymer is a first copolymer, and the resin composition further comprises a second copolymer, which comprises a structural unit of Formula (3-1) and a structural unit of Formula (3-2),

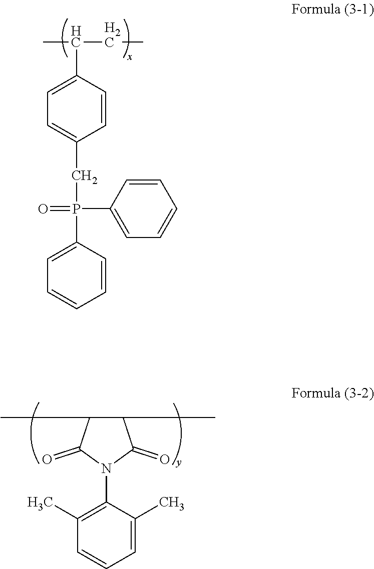

wherein x and y independently represent a repeating number of unit in the brackets by which the second copolymer has a weight average molecular weight of between 1,000 and 30,000; and
the second copolymer has a phosphorus content of greater than or equal to 7%.

For example, in one embodiment, the resin composition further comprises 5 to 10 parts by weight of a second copolymer.

For example, in one embodiment, the resin composition further comprises inorganic filler, curing accelerator, flame retardant, polymerization inhibitor, solvent, silane coupling agent, coloring agent, toughening agent or a combination thereof.

To achieve the above-mentioned objects, the present disclosure further provides an article made from the resin composition, including a prepreg, a resin film, a laminate or a printed circuit board.

For example, in one embodiment, articles made from the resin composition disclosed herein have one, more or all of the following properties:
a dielectric constant as measured by reference to JIS C2565 at 10 GHz of less than or equal to 3.33;
a dissipation factor as measured by reference to JIS C2565 at 10 GHz of less than or equal to 0.0026;
a copper foil peeling strength as measured by reference to IPC-TM-650 2.4.8 of greater than or equal to 3.21 lb/in;
a flame retardancy of V-O rating as measured by reference to UL94 standard;
a glass transition temperature as measured by reference to IPC-TM-650 2.4.24.4 of greater than or equal to 190° C.; and
a water absorption ratio after 5 hours of moisture absorption in a pressure cooking test as measured by reference to IPC-TM-650 2.6.16.1 of less than or equal to 0.28%.

### DESCRIPTION OF THE EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

While some theories or mechanisms may be proposed herein, the present disclosure is not bound by any theories or mechanisms described regardless of whether they are right or wrong, as long as the embodiments can be implemented according to the present disclosure.

As used herein, “a,” “an” or any similar expression is employed to describe components and features of the present disclosure. This is done merely for convenience and to give a general sense of the scope of the present disclosure. Accordingly, this description should be read to include one or at least one and the singular also includes the plural unless it is obvious to mean otherwise.

As used herein, the term “comprises,” “comprising,” “includes,” “including,” “has,” “having” or any other variant thereof is construed as an open-ended transitional phrase intended to cover a non-exclusive inclusion. For example, a composition comprising a list of elements or an article made therefrom encompasses any one or any type of the listed elements and is not necessarily limited to only those elements listed herein, but may also include other elements not expressly listed or inherent to such composition or article. Further, unless expressly stated to the contrary, the term “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). In addition, whenever open-ended transitional phrases are used, such as “encompasses,” “encompassing,” “comprises,” “comprising,” “includes,” “including,” “has,” “having” or any other variant thereof, it is understood that close-ended transitional phrases such as “consisting of,” “composed by” and “remainder being” and partially open-ended transitional phrases such as “consisting essentially of,” “primarily consisting of,” “mainly consisting of,” “primarily containing,” “composed essentially of,” “essentially having,” etc. are also disclosed and included.

As used herein, “or a combination thereof” means “or any combination thereof”, which encompasses any combination of two or more of the listed elements, and “any” means “any one”, vice versa. For example, “a composition or an article made therefrom includes A, B, C or a combination thereof” is construed to encompass the following situations: A is true (or present), and B and C are false (or not present); B is true (or present), and A and C are false (or not present); C is true (or present), and A and B are false (or not present); A and B are true (or present), and C is false (or not present); A and C are true (or present), and B is false (or not present); B and C are true (or present), and A is false (or not present); A and B and C are all true (or present), and other elements not expressly listed but inherent to such composition or article.

As used herein, the term “and” or any other variant thereof is used to connect parallel sentence components, and there is no distinction between the front and rear components. The meaning of the parallel sentence components does not change in the grammatical sense after the position is exchanged.

In this disclosure, features and conditions such as values, numbers, contents, amounts or concentrations are presented as a numerical range or a percentage range merely for convenience and brevity. Therefore, a numerical range or a percentage range should be interpreted as encompassing and specifically disclosing all possible subranges and individual numerals or values therein, including integers and fractions, particularly all integers therein. For example, a range of “1.0 to 8.0” or “between 1.0 and 8.0” should be understood as explicitly disclosing all subranges such as 1.0 to 8.0, 1.0 to 7.0, 2.0 to 8.0, 2.0 to 6.0, 3.0 to 6.0, 4.0 to 8.0, 3.0 to 8.0 and so on and encompassing the endpoint values, particularly subranges defined by integers, as well as disclosing all individual values in the range such as 1.0, 2.0, 3.0, 4.0, 5.0, 6.0, 7.0 and 8.0. Unless otherwise defined, the aforesaid interpretation rule should be applied throughout the present disclosure regardless of broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40.0 should be understood as covering a range of 39.50 to 40.49.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X1, X2 and X3,” it is intended to disclose the situations of X is X1 and X is X1 and/or X2 and/or X3. In addition, when a Markush group or a list of items is used to describe examples or embodiments of the present disclosure, a skilled artisan will understand that any subgroup or any combination of the members or items in the Markush group or list may also be used to describe the present disclosure. Therefore, for example, when X is described as being “selected from a group consisting of X1, X2 and X3” and Y is described as being “selected from a group consisting of Y1, Y2 and Y3,” the disclosure includes any combination of X is X1 and/or X2 and/or X3 and Y is Y1 and/or Y2 and/or Y3.

Unless otherwise specified, according to the present disclosure, a compound refers to a chemical substance formed by two or more elements bonded with chemical bonds and may comprise a small molecule compound and a polymer compound, but not limited thereto. Any compound disclosed herein is interpreted to not only include a single chemical substance but also include a class of chemical substances having the same kind of components or having the same property.

Unless otherwise specified, according to the present disclosure, a polymer refers to the product formed by monomer(s) via polymerization and usually comprises multiple aggregates of polymers respectively formed by multiple repeated simple structure units by covalent bonds; the monomer refers to the compound forming the polymer. A polymer may comprise a homopolymer, a copolymer, a prepolymer, etc., but not limited thereto. A homopolymer refers to the polymer formed by the polymerization of one monomer. A copolymer refers to the polymer formed by the polymerization of two or more types of monomers. Copolymers comprise: random copolymers, such as a structure of -AABABBBAAABBA-; alternating copolymers, such as a structure of -ABABABAB-; graft copolymers, such as a structure of -AA(A-BBBB)AA(A-BBBB)AAA-; and block copolymers, such as a structure of -AAAAA-BBBBBB-AAAAA-. A prepolymer refers to a polymer having a lower molecular weight between the molecular weight of monomer and the molecular weight of final polymer, and a prepolymer contains a reactive functional group capable of participating further polymerization to obtain the final polymer product which has been fully crosslinked or cured. Unless otherwise specified, as used herein, the term “polymer” includes but is not limited to an oligomer. An oligomer refers to a polymer with 2-20, typically 2-5, repeating units.

Unless otherwise specified, the term “resin” of the present disclosure is a widely used common name of a synthetic polymer and is construed as comprising monomer and its combination, polymer and its combination or a combination of monomer and its polymer, but not limited thereto.

Unless otherwise specified, as used herein, the term “vinyl group-containing” is construed to encompass the inclusion of a vinyl group, a vinylbenzyl group, a vinylene group, an allyl group or a (meth)acrylate group, but not limited thereto.

Unless otherwise specified, the alkyl group, the alkenyl group and the monomer described herein are construed to encompass various isomers thereof. For example, a propyl group is construed to encompass n-propyl and iso-propyl.

Unless otherwise specified, as used herein, part(s) by weight represents weight part(s) in any weight unit in the resin composition, such as but not limited to kilogram, gram, pound and so on. For example, 100 parts by weight of a vinyl group-containing polyphenylene ether resin may represent 100 kilograms of the vinyl group-containing polyphenylene ether resin or 100 pounds of the vinyl group-containing polyphenylene ether resin.

It should be understood that all features disclosed herein may be combined in any way to constitute the technical solution of the present disclosure, as long as there is no conflict present in the combination of these features.

The following embodiments and examples are illustrative in nature and are not intended to limit the present disclosure and its application. In addition, the present disclosure is not bound by any theory described in the background and summary above or the following embodiments or examples. Unless otherwise specified, processes, reagents and conditions described in the examples are those known in the art.

As described above, a primary object of the present disclosure is to provide a vinyl group-containing phosphoric copolymer, which comprises a structural unit of Formula (1-1) and a structural unit of Formula (1-2),

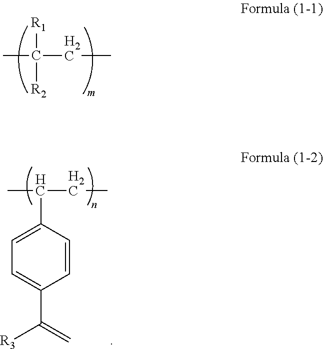

In Formula (1-1) and Formula (1-2), m and n independently represent a repeating number of unit in the brackets (neither m nor n is 0) by which the vinyl group-containing phosphoric copolymer has a weight average molecular weight of between 1,000 and 50,000. In other words, the value of m and n is not particularly limited as long as the vinyl group-containing phosphoric copolymer has a weight average molecular weight of between 1,000 and 50,000. For example, m may be any number between 2 and 120, such as 2, 5, 10, 20, 30, 40, 50, 60, 70, 80, 90, 100, 110 or 120, and n may be any number between 3 and 500, such as 3, 5, 10, 50, 100, 150, 200, 250, 300, 350, 400, 450, 490 or 500. For example, the weight average molecular weight of the vinyl group-containing phosphoric copolymer may be about 1,000, 3,000, 5,000, 7,000, 9,000, 10,000, 15,000, 20,000, 25,000, 30,000, 35,000, 40,000, 45,000 or 50,000.

In Formula (1-1) and Formula (1-2), R₁ and R₃ are each independently a hydrogen atom or a C1 to C3 alkyl group (such as methyl, ethyl, n-propyl or isopropyl). R₂ is a monovalent functional group selected from a group consisting of Formula (1-3) to Formula (1-8), wherein r and q are independently an integer of 0 to 3 (such as 0, 1, 2 or 3):

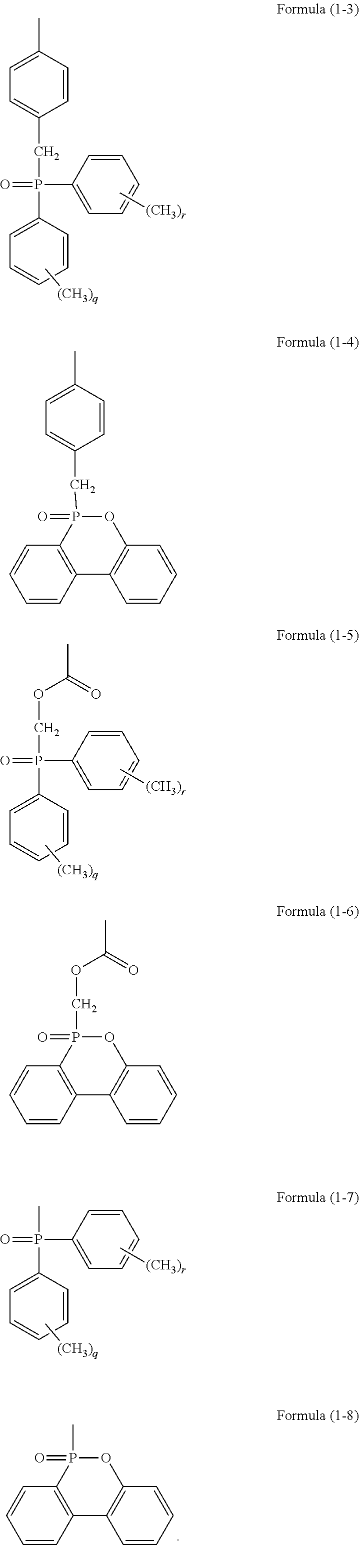

The vinyl group-containing phosphoric copolymer of the present disclosure has a phosphorus content of greater than or equal to 7%, such as greater than or equal to 7%, greater than or equal to 7.5%, greater than or equal to 8%, greater than or equal to 8.5%, greater than or equal to 9%, greater than or equal to 9.5%, or greater than or equal to 9.9%. For example, the vinyl group-containing phosphoric copolymer has a phosphorus content of between 7% and 10%.

The vinyl group-containing phosphoric copolymer may be a random copolymer, an alternating copolymer, a graft copolymer or a block copolymer. In other words, the structural unit of Formula (1-1) and the structural unit of Formula (1-2) may be connected in any way to form the vinyl group-containing phosphoric copolymer of the present disclosure.

The vinyl group-containing phosphoric copolymer contains a phosphorus atom (such as DPPO group or DOPO group) in the structure, so it can provide flame retardant effects. In addition, the vinyl group-containing phosphoric copolymer also contains a reactive vinyl group in the structure, so it can react with other components in the resin composition, such as by a crosslinking reaction.

For example, in one embodiment, an article made from the vinyl group-containing phosphoric copolymer of the present disclosure may achieve improvements in one or more properties including dissipation factor and solvent compatibility. For example, the article made from the vinyl group-containing phosphoric copolymer of the present disclosure, such as a copper-free laminate, preferably has a dissipation factor of less than or equal to 0.0025, such as less than or equal to 0.0025, less than or equal to 0.0024, less than or equal to 0.0023, or less than or equal to 0.0022; for example, the dissipation factor is between 0.0022 and 0.0025. The dissipation factor is measured by reference to JIS C2565 at 10 GHz. For example, the vinyl group-containing phosphoric copolymer of the present disclosure and a solvent (such as methyl ethyl ketone, toluene or a combination thereof) were placed in a transparent glass bottle and stirred evenly, and then stood still at room temperature (about 25° C.) for 24 hours. Absence of precipitation was observed by visual inspection, indicating that the vinyl group-containing phosphoric copolymer of the present disclosure has a good solvent compatibility.

The vinyl group-containing phosphoric copolymer of the present disclosure may be prepared by various methods. For example, in one embodiment, an aldehyde (such as formaldehyde) and a triphenylphosphine dipole (as a Wittig reagent, such as 4-vinylbenzyl(triphenyl)phosphonium chloride) are subject to a Wittig reaction in an alkaline environment (such as potassium hydroxide) to generate olefin (such as divinylbenzene) and triphenylphosphine oxide. The olefin may be reacted with a phosphorus-containing compound (such as p-vinylbenzyl-DPPO) to prepare the vinyl group-containing phosphoric copolymer of the present disclosure.

On the other hand, the present disclosure also provides a resin composition, comprising 100 parts by weight of a vinyl group-containing polyphenylene ether resin and 55 to 80 parts by weight of the vinyl group-containing phosphoric copolymer. In other words, relative to 100 parts by weight of the vinyl group-containing polyphenylene ether resin, the resin composition of the present disclosure may comprise 55, 60, 65, 70, 75 or 80 parts by weight of the vinyl group-containing phosphoric copolymer.

For example, in one embodiment, in the resin composition of the present disclosure, the content of phosphorus atom is preferably greater than or equal to 2%, more preferably greater than or equal to 2.4%, such as between 2% and 4% and between 2.4% and 3.5%, but not limited thereto.

For example, in one embodiment, the vinyl group-containing polyphenylene ether resin may comprise various polyphenylene ether resins with terminals modified by a vinyl group or an allyl group. In addition, the vinyl group-containing polyphenylene ether resin may also be a polyphenylene ether resin with terminals modified by a (meth)acrylate.

For example, in one embodiment, the vinyl group-containing polyphenylene ether resin represents a polyphenylene ether resin containing a vinyl group, and examples thereof may include but not limited to a polyphenylene ether resin containing a vinyl group, an allyl group, a vinylbenzyl group or a (meth)acrylate group. For example, in one embodiment, the vinyl group-containing polyphenylene ether resin comprises a vinylbenzyl group-containing biphenyl polyphenylene ether resin, a (meth)acrylate group-containing polyphenylene ether resin (i.e., (meth)acryloyl group-containing polyphenylene ether resin), an allyl group-containing polyphenylene ether resin, a vinylbenzyl group-modified bisphenol A polyphenylene ether resin, a chain-extended vinyl group-containing polyphenylene ether resin or a combination thereof. For example, the vinyl group-containing polyphenylene ether resin may be a vinylbenzyl group-containing biphenyl polyphenylene ether resin with a number average molecular weight of about 1200 (such as OPE-2st 1200, available from Mitsubishi Gas Chemical Co., Inc.), a vinylbenzyl group-containing biphenyl polyphenylene ether resin with a number average molecular weight of about 2200 (such as OPE-2st 2200, available from Mitsubishi Gas Chemical Co., Inc.), a methacrylate group-containing polyphenylene ether resin with a number average molecular weight of about 1900 to 2300 (such as SA9000, available from Sabic), a vinylbenzyl group-modified bisphenol A polyphenylene ether resin with a number average molecular weight of about 2400 to 2800, a chain-extended vinyl group-containing polyphenylene ether resin with a number average molecular weight of about 2200 to 3000, or a combination thereof. The chain-extended vinyl group-containing polyphenylene ether resin may include various polyphenylene ether resins disclosed in the US Patent Application Publication No. 2016/0185904 A1, all of which are incorporated herein by reference in their entirety.

In addition to the aforesaid components, the resin composition of the present disclosure may also optionally comprise other components.

For example, in one embodiment, the resin composition of the present disclosure further comprises a multi-functional aromatic vinyl group-containing compound. The amount of the multi-functional aromatic vinyl group-containing compound is not particularly limited and may be adjusted according to the need. For example, in one embodiment, relative to 100 parts by weight of the vinyl group-containing polyphenylene ether resin, the resin composition of the present disclosure further comprises 5 to 25 parts by weight of a multi-functional aromatic vinyl group-containing compound, such as 5, 10, 15, 20 or 25 parts by weight of a multi-functional aromatic vinyl group-containing compound.

The type of the multi-functional aromatic vinyl group-containing compound is not particularly limited. For example, in one embodiment, the multi-functional aromatic vinyl group-containing compound has a structure of Formula (2):

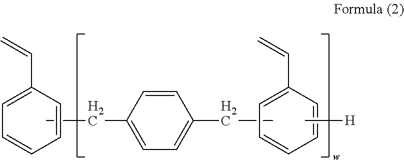

wherein w represents the repeating number of the structural unit in the brackets, and w is between 1 and 20, such as 1, 2, 3, 4, 5, 6, 7, 8, 9, 10, 11, 12, 13, 14, 15, 16, 17, 18, 19 or 20.

For example, in one embodiment, the resin composition of the present disclosure further comprises a copolymer different from the aforesaid vinyl group-containing phosphoric copolymer. For example, in one embodiment, if the vinyl group-containing phosphoric copolymer is used as a first copolymer, the resin composition of the present disclosure may further comprise a second copolymer, and the second copolymer includes a structural unit of Formula (3-1) and a structural unit of Formula (3-2):

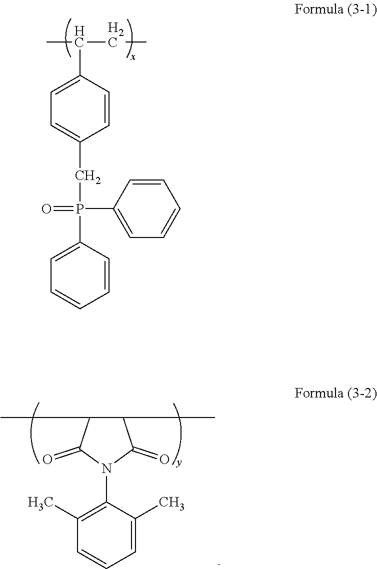

In Formula (3-1) and Formula (3-2), x and y independently represent a repeating number of unit in the brackets by which the second copolymer has a weight average molecular weight of between 1,000 and 30,000. For example, x may be any value between 2 and 70, such as 2, 5, 10, 20, 30, 40, 50, 60 or 70, and y may be any value between 2 and 150, such as 2, 5, 10, 50, 100, or 150. For example, the weight average molecular weight of the second copolymer may be about 1,000, 3,000, 5,000, 7,000, 9,000, 10,000, 15,000, 20,000, 25,000 or 30,000.

For example, in one embodiment, the second copolymer has a phosphorus content of greater than or equal to 7%, such as greater than or equal to 7%, greater than or equal to 7.5%, greater than or equal to 8%, greater than or equal to 8.5%, greater than or equal to 9%, greater than or equal to 9.5%, or greater than or equal to 9.9%. For example, the second copolymer has a phosphorus content of between 7% and 10%.

The second copolymer may be a random copolymer, an alternating copolymer, a graft copolymer or a block copolymer. In other words, the structural unit of Formula (3-1) and the structural unit of Formula (3-2) may connected in any way to form the second copolymer.

The amount of the second copolymer is not particularly limited and may be adjusted according to the need. For example, in one embodiment, relative to 100 parts by weight of the vinyl group-containing polyphenylene ether resin, the resin composition of the present disclosure further comprises 5 to 10 parts by weight of a second copolymer.

In addition to the aforesaid components, the resin composition of the present disclosure may further optionally comprise inorganic filler, curing accelerator, flame retardant, polymerization inhibitor, solvent, silane coupling agent, coloring agent, toughening agent or a combination thereof. Unless otherwise specified, relative to 100 parts by weight of the vinyl group-containing polyphenylene ether resin, the content of any aforesaid component may be 0.1 to 300 parts by weight, such as 0.01, 0.1, 0.5, 1, 5, 10, 20, 30, 40, 50, 60, 70, 80, 90, 100, 150, 200, 250 or 300 parts by weight, such as 1 to 100 parts by weight, 30 to 150 parts by weight or 200 to 300 parts by weight, but not limited thereto.

For example, the inorganic filler may be any one or more inorganic fillers suitable for preparing a prepreg, a resin film, a laminate or a printed circuit board, examples including but not limited to silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate-modified talc, zinc oxide, zirconium oxide, mica, boehmite (AlOOH), calcined talc, talc, silicon nitride, or calcined kaolin. Moreover, the inorganic filler can be spherical, fibrous, plate-like, particulate, flake-like or whisker-like in shape and can be optionally pretreated by a silane coupling agent. For example, relative to 100 parts by weight of the vinyl group-containing polyphenylene ether resin, the amount of inorganic filler used in the present disclosure is not particularly limited, and may range from 80 parts by weight to 180 parts by weight, preferably 100 parts by weight to 150 parts by weight. For example, in one embodiment, the resin composition of the present disclosure comprises 100 parts by weight of a vinyl group-containing polyphenylene ether resin, 55 to 80 parts by weight of a vinyl group-containing phosphoric copolymer and 5 to 40 parts by weight of boron nitride, and an article made therefrom may achieve improvements in thermal conductivity and dissipation factor.

For example, the curing accelerator (including curing initiator) may comprise a catalyst, such as a Lewis base or a Lewis acid. The Lewis base may comprise any one or more of imidazole, boron trifluoride-amine complex, ethyltriphenyl phosphonium chloride, 2-methylimidazole (2 MI), 2-phenyl-1H-imidazole (2PZ), 2-ethyl-4-methylimidazole (2E4 MI), triphenylphosphine (TPP) and 4-dimethylaminopyridine (DMAP). The Lewis acid may comprise metal salt compounds, such as those of manganese, iron, cobalt, nickel, copper and zinc, such as zinc octanoate or cobalt octanoate. The curing accelerator also includes a curing initiator, such as a peroxide capable of producing free radicals, examples of curing initiator including but not limited to dicumyl peroxide, tert-butyl peroxybenzoate, dibenzoyl peroxide (BPO), 2,5-dimethyl-2,5-di(tert-butylperoxy)-3-hexyne (25B), bis(tert-butylperoxyisopropyl)benzene or a combination thereof.

For example, the flame retardant used herein may be any one or more flame retardants useful for preparing a prepreg, a resin film, a laminate or a printed circuit board, examples including but not limited to a phosphorus-containing flame retardant, preferably comprising: ammonium polyphosphate, hydroquinone bis-(diphenyl phosphate), bisphenol A bis-(diphenylphosphate), tri(2-carboxyethyl) phosphine (TCEP), phosphoric acid tris(chloroisopropyl) ester, trimethyl phosphate (TMP), dimethyl methyl phosphonate (DMMP), resorcinol bis(dixylenyl phosphate) (RDXP, such as commercially available PX-200, PX-201, and PX-202), phosphazene (such as commercially available SPB-100, SPH-100, and SPV-100), melamine polyphosphate, DOPO (9,10-dihydro-9-oxa-10-phosphaphenanthrene-10-oxide) and its derivatives or resins, DPPO (diphenylphosphine oxide) and its derivatives or resins, melamine cyanurate, tri-hydroxy ethyl isocyanurate, aluminium phosphinate (e.g., commercially available OP-930 and OP-935), or a combination thereof.

For example, the flame retardant may be a DPPO compound (e.g., di-DPPO compound, such as commercially available PQ-60), a DOPO compound (e.g., di-DOPO compound), a DOPO resin (e.g., DOPO-HQ, DOPO-NQ, DOPO-PN, and DOPO-BPN) and a DOPO-containing epoxy resin, wherein DOPO-PN is a DOPO phenol novolac compound, and DOPO-BPN may be a DOPO-containing bisphenol novolac compound, such as DOPO-BPAN (DOPO-bisphenol A novolac), DOPO-BPFN (DOPO-bisphenol F novolac) or DOPO-BPSN (DOPO-bisphenol S novolac). The content of the flame retardant may be adjusted according to the need, and the resin composition may contain no flame retardant, which means the content of the flame retardant is 0 part by weight, representing that the resin composition is not specifically added with a flame retardant.

For example, the polymerization inhibitor may comprise, but not limited to, 1,1-diphenyl-2-picrylhydrazyl radical, methyl acrylonitrile, 2,2,6,6-tetramethyl-1-oxo-piperidine, dithioester, nitroxide-mediated radical, triphenylmethyl radical, metal ion radical, sulfur radical, hydroquinone, 4-methoxyphenol, p-benzoquinone, phenothiazine, β-phenylnaphthylamine, 4-t-butylcatechol, methylene blue, 4,4′-butylidenebis(6-t-butyl-3-methylphenol), 2,2′-methylenebis(4-ethyl-6-t-butylphenol) or a combination thereof. For example, the nitroxide-mediated radical may comprise, but not limited to, nitroxide radicals derived from cyclic hydroxylamines, such as 2,2,6,6-substituted piperidine 1-oxyl free radical, 2,2,5,5-substituted pyrrolidine 1-oxyl free radical or the like. Preferred substitutes include alkyl groups with 4 or fewer carbon atoms, such as methyl group or ethyl group. Examples of the compound containing a nitroxide radical include but are not limited to 2,2,6,6-tetramethylpiperidine 1-oxyl free radical, 2,2,6,6-tetraethylpiperidine 1-oxyl free radical, 2,2,6,6-tetramethyl-4-oxo-piperidine 1-oxyl free radical, 2,2,5,5-tetramethylpyrrolidine 1-oxyl free radical, 1,1,3,3-tetramethyl-2-isoindoline oxygen radical, N,N-di-tert-butylamine oxygen free radical and so on. Nitroxide radicals may also be replaced by using stable radicals such as galvinoxyl radicals. The polymerization inhibitor suitable for the resin composition of the present disclosure may include products derived from the polymerization inhibitor with its hydrogen atom or group substituted by other atom or group. Examples include products derived from a polymerization inhibitor with its hydrogen atom substituted by an amino group, a hydroxyl group, a carbonyl group or the like.

For example, the solvent suitable for the resin composition of the present disclosure is not particularly limited and may be any solvent suitable for dissolving the resin composition disclosed herein, examples including, but not limited to, methanol, ethanol, ethylene glycol monomethyl ether, anisole, acetone, butanone (methyl ethyl ketone), methyl isobutyl ketone, cyclohexanone, toluene, xylene, methoxyethyl acetate, ethoxyethyl acetate, propoxyethyl acetate, ethyl acetate, dimethylformamide, dimethylacetamide, propylene glycol methyl ether, or a mixture thereof. The amount of solvent is not particularly limited and may be adjusted according to the viscosity required for the resin composition. For example, in one embodiment, the amount of the solvent is added in order to adjust the total solid content of the resin composition to 50 wt % to 85 wt %, but not limited thereto.

For example, the silane coupling agent may comprise silane (such as but not limited to siloxane) and may be further categorized according to the functional groups into amino silane, epoxide silane, vinyl silane, acrylate silane, methacrylate silane, hydroxyl silane, isocyanate silane, methacryloyloxy silane and acryloyloxy silane.

Unless otherwise specified, the coloring agent suitable for the present disclosure may comprise, but not limited to, dye or pigment.

According to the present disclosure, the main purpose of adding a toughening agent is to improve the toughness of the resin composition. For example, the toughening agent suitable for the present disclosure may comprise, but not limited to, carboxyl-terminated butadiene acrylonitrile rubber (CTBN rubber), core-shell rubber, ethylene propylene rubber or a combination thereof.

For example, in one embodiment, the resin composition of the present disclosure may further comprise a maleimide resin, a polyolefin, a small molecule vinyl compound or a combination thereof.

For example, in one embodiment, the maleimide resin comprises a monomer containing at least one maleimide group or a combination thereof. Unless otherwise specified, the maleimide resin used in the present disclosure is not particularly limited and may include any one or more maleimide resins useful for preparing a prepreg, a resin film, a laminate or a printed circuit board. In some embodiments, the maleimide resin includes 4,4′-diphenylmethane bismaleimide, oligomer of phenylmethane maleimide (a.k.a. polyphenylmethane maleimide), bisphenol A diphenyl ether bismaleimide, 3,3′-dimethyl-5,5′-diethyl-4,4′-diphenylmethane bismaleimide (a.k.a. bis(3-ethyl-5-methyl-4-maleimidephenyl) methane), 3,3′-dimethyl-5,5′-dipropyl-4,4′-diphenylmethane bismaleimide, biphenyl maleimide, m-phenylene bismaleimide, 4-methyl-1,3-phenylene bismaleimide, 1,6-bismaleimide-(2,2,4-trimethyl) hexane, N-2,3-xylylmaleimide, N-2,6-xylylmaleimide, N-phenylmaleimide, diethyl bismaleimidotoluene, vinyl benzyl maleimide (VBM), maleimide resin containing aliphatic long chain structure, or a combination thereof. Unless otherwise specified, the maleimide resins described above should be construed as including the modifications thereof.

For example, examples of the maleimide resin may include products such as BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000 and BMI-7000H available from Daiwakasei Industry, products such as BMI-70 and BMI-80 available from K.I Chemical Industry Co., Ltd., products such as MIR-3000 and MIR-5000 available from Nippon Kayaku, or products such as DE-TDAB available from Evonik Industries.

For example, the maleimide resin containing aliphatic long chain structure may include products such as BMI-689, BMI-1400, BMI-1500, BMI-1700, BMI-2500, BMI-3000, BMI-5000 and BMI-6000 available from Designer Molecules Inc.

For example, in one embodiment, the polyolefin comprises polybutadiene, polyisoprene, styrene-butadiene copolymer, styrene-isoprene copolymer, styrene-butadiene-divinylbenzene terpolymer, maleic anhydride-adducted styrene-butadiene copolymer, vinyl-polybutadiene-urethane oligomer, maleic anhydride-adducted butadiene copolymer, polymethylstyrene, hydrogenated polybutadiene, hydrogenated styrene-butadiene-divinylbenzene terpolymer, maleic anhydride-adducted hydrogenated styrene-butadiene copolymer, hydrogenated styrene-butadiene copolymer, hydrogenated styrene-isoprene copolymer, olefin rubber (polyoctenamer rubber, ethylene propylene rubber (EPM), ethylene propylene diene rubber (EPDM), etc.) or a combination thereof.

For example, in one embodiment, the small molecule vinyl group-containing compound refers to a vinyl group-containing compound with a molecular weight of less than or equal to 1000, preferably between 100 and 900 and more preferably between 100 and 800. In one embodiment, the small molecule vinyl compound may include, but not limited to, divinylbenzene, bis(vinylbenzyl) ether (BVBE), bis(vinylphenyl) ethane (BVPE), triallyl isocyanurate (TAIC), triallyl cyanurate (TAC), 1,2,4-trivinyl cyclohexane (TVCH) or a combination thereof.

The resin composition of various embodiments may be processed to make different articles, such as those suitable for use as components in electronic products, including but not limited to a prepreg, a resin film, a laminate or a printed circuit board.

For example, the resin compositions of various embodiments may be used to make prepregs.

For example, the prepreg disclosed herein has a reinforcement material and a layered structure formed thereon, wherein the layered structure is made by heating the resin composition at high temperature to a semi-cured state (B-stage). Suitable baking temperature for making the prepreg may be for example 100° C. to 140° C. The reinforcement material may be a fiber material or a non-fiber material, configured as any one of woven fabric and non-woven fabric, and the woven fabric preferably comprises fiberglass fabrics. Types of fiberglass fabrics are not particularly limited and may be any commercial fiberglass fabric useful for various printed circuit boards, such as E-glass fiber fabric, D-glass fiber fabric, S-glass fiber fabric, T-glass fiber fabric, L-glass fiber fabric or Q-glass fiber fabric, wherein the fiber may comprise yarns and rovings, in spread form or standard form. Non-woven fabric preferably comprises liquid crystal polymer non-woven fabric, such as polyester non-woven fabric, polyurethane non-woven fabric and so on, but not limited thereto. Woven fabric may also comprise liquid crystal polymer woven fabric, such as polyester woven fabric, polyurethane woven fabric and so on, but not limited thereto. The reinforcement material may increase the mechanical strength of the prepreg. In one preferred embodiment, the reinforcement material can be optionally pre-treated by a silane coupling agent. The prepreg may be further heated and cured to the C-stage to form an insulation layer.

For example, by well mixing the resin composition to form a varnish, loading the varnish into an impregnation tank, impregnating a fiberglass fabric into the impregnation tank to adhere the resin composition onto the fiberglass fabric, and finally heating and baking the resin composition at a proper temperature to a semi-cured state, a prepreg may be obtained.

For example, the article made from the resin composition disclosed herein may be a resin film.

For example, in one embodiment, the resin film disclosed herein is prepared by heating and baking the resin composition to the semi-cured state (B-stage). For example, the resin composition may be selectively coated on a liquid crystal polymer film, a polyethylene terephthalate film (PET film) or a polyimide film; for example, the resin composition from each embodiment may be coated on a copper foil to uniformly adhere the resin composition thereon, followed by heating and baking at 100° C. to 140° C. for 3 to 10 minutes to a semi-cured state to form a resin film, so as to obtain a copper-clad resin film (i.e., resin-coated copper).

For example, the resin compositions of various embodiments may be used to make laminates.

For example, in one embodiment, the laminate of the present disclosure comprises at least two metal foils and an insulation layer disposed between the metal foils, wherein the insulation layer is made by curing the resin composition at high temperature and high pressure to the C-stage, a suitable curing temperature being for example between 180° C. and 240° C. and preferably between 200° C. and 220° C. and a suitable curing time being 60 to 150 minutes and preferably 90 to 120 minutes. The insulation layer may be formed by curing the aforesaid prepreg or resin film to the C-stage. The metal foil may comprise copper, aluminum, nickel, platinum, silver, gold or alloy thereof, such as a copper foil. In one embodiment, the laminate is a copper-clad laminate (CCL).

In addition, the laminate may be further processed by trace formation processes to make a circuit board, such as a printed circuit board.

In one embodiment, the resin composition disclosed herein or an article made therefrom may achieve improvement in one or more of the following properties: dielectric constant, dissipation factor, copper foil peeling strength, flame retardancy, glass transition temperature and PCT water absorption ratio.

For example, in one embodiment, the resin composition disclosed herein or the article made therefrom has one, more or all of the following properties:
a dielectric constant as measured by reference to JIS C2565 at 10 GHz of less than or equal to 3.33, such as between 3.01 and 3.33;
a dissipation factor as measured by reference to JIS C2565 at 10 GHz of less than or equal to 0.0026, such as between 0.0013 and 0.0026;
a copper foil peeling strength as measured by reference to IPC-TM-650 2.4.8 of greater than or equal to 3.21 lb/in, such as between 3.21 lb/in and 3.46 lb/in;
a flame retardancy of V-O rating as measured by reference to UL94 standard;
a glass transition temperature as measured by reference to IPC-TM-650 2.4.24.4 of greater than or equal to 190° C., such as between 190° C. and 219° C.; and
a water absorption ratio after 5 hours of moisture absorption in a pressure cooking test as measured by reference to IPC-TM-650 2.6.16.1 of less than or equal to 0.28%, such as between 0.16% and 0.28%.

Various copolymers were prepared according to the descriptions of Synthesis Example 1 to Synthesis Example 15. In addition, raw materials below were used to prepare the resin compositions of various Examples and Comparative Examples of the present disclosure according to the amount listed in Table 1 to Table 5 and further fabricated to prepare test samples.

Materials and reagents used in Synthesis Examples of copolymer and Examples and Comparative Examples of resin composition disclosed herein are listed below:
CP1 to CP15: vinyl group-containing phosphoric copolymer, as a first copolymer, as described in Synthesis Example 1 to Synthesis Example 15.
SA9000: methacrylate group-containing polyphenylene ether resin, available from Sabic.
DPPE-VBT50: vinyl group-containing polyphenylene ether resin, available from DKS Co. Ltd.
MIR-5000: biphenyl aralkyl maleimide resin, available from Nippon Kayaku.
BMI-3000: maleimide resin containing aliphatic long-chain structure, available from Designer Molecules Inc.
Ricon 100: styrene-butadiene copolymer, available from Cray Valley.
Ricon 257: styrene-butadiene-divinylbenzene terpolymer, available from Cray Valley.
BVPE: 1,2-bis(p-vinylphenyl) ethane, commercially available.
ESTENAMER 8012: trans-polyoctenamer rubber,
available from Akrochem.
p-Vinylbenzyl-DPPO: as shown below, available from Shandong Xingshun New Materials Co., Ltd.

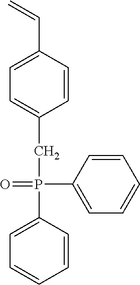 [SMILES: C=Cc1ccc(CP(=O)(c2ccccc2)c2ccccc2)cc1]

p-Vinylbenzyl-DOPO: as shown below, available from CHENG CI CORPORATION.

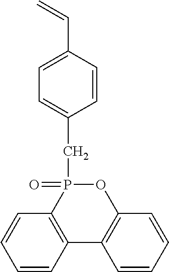 [SMILES: C=Cc1ccc(CP2(=O)Oc3ccccc3-c3ccccc32)cc1]

Vinyl-DOPO: as shown below, available from Shandong Xingshun New Materials Co., Ltd.

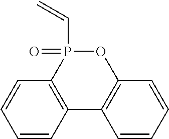 [SMILES: C=CP1(=O)Oc2ccccc2-c2ccccc21]

Divinylbenzene (DVB): commercially available.
Multi-functional aromatic vinyl group-containing compound: having a structure of Formula (2), as described in Synthesis Example 16.
Second copolymer: containing the structural unit of Formula (3-1) and the structural unit of Formula (3-2), as described in Synthesis Example 17.
SC2050: silica, available from Admatechs.
Azo compound: 2,2′-azobis(2,4,4-trimethylpentane), available from FUJIFILM Wako Pure Chemical.
Anisole: commercially available.

### Synthesis Example 1

p-Vinylbenzyl-DPPO, 4-vinylbenzyl(triphenyl)phosphonium chloride (available from Shandong Xingshun New Materials Co., Ltd.), 0.5 wt % of 2,2′-azobis(2,4,4-trimethylpentane) relative to the total weight of the aforesaid raw materials and a solvent (such as dimethylacetamide, DMAc) were added into a three-necked flask, and a solid content was about 30 wt %, wherein the molar ratio of p-vinylbenzyl-DPPO to 4-vinylbenzyl(triphenyl)phosphonium chloride was 2.1:2.0. A mixture solution was obtained by stirring continuously, followed by heating from room temperature to 120° C. and stirring continuously for 16 hours. After purification, relative to the purified product, 9 wt % of formaldehyde, 2 wt % of potassium hydroxide and an appropriate amount of tetrahydrofuran (THF) were added and reacted for 4 hours. The mixture solution was purified by methanol/water at a weight ratio of 7/3 to obtain Copolymer CP1, which is the vinyl group-containing phosphoric copolymer of the present disclosure. Copolymer CP1 includes the structural unit of Formula (1-1) and the structural unit of Formula (1-2), wherein R₁ is a hydrogen atom, R₂ is the structure of Formula (1-3) and r and q are both 0, and R₃ is a hydrogen atom. The phosphorus content of Copolymer CP1 is 7.0%, and the weight average molecular weight of Copolymer CP1 is about 18,900 as measured by GPC.

As used herein, unless otherwise specified, the weight average molecular weight (Mw) is calculated by converting the results measured using gel permeation chromatography (GPC) compared to standard polystyrene. The measuring device used in gel permeation chromatography was HLC-8020 chromatograph sold by TOSOH, and the sample was passed through the TSK guard column HXL-H TSK gel GMHXL (×2) and TSK gel G2000HXL column sold by TOSOH in said sequence. The solvent used was tetrahydrofuran, and the measurement temperature was 40° C.

### Synthesis Example 2

p-Vinylbenzyl-DOPO, divinylbenzene, 0.5 wt % of azobisisobutyronitrile (AIBN) relative to the total weight of the aforesaid raw materials and a solvent (such as DMAc) were added into a three-necked flask, and a solid content was about 30 wt %, wherein the molar ratio of p-vinylbenzyl-DOPO to divinylbenzene was 1.2:1.0. A mixture solution was obtained by stirring continuously, followed by heating from room temperature to 70° C. and stirring continuously for 13 hours. The temperature was then raised to 110° C. and stirred continuously for 13 hours. After purification, Copolymer CP2 was obtained, which is the vinyl group-containing phosphoric copolymer of the present disclosure. Copolymer CP2 includes the structural unit of Formula (1-1) and the structural unit of Formula (1-2), wherein R₁ is a hydrogen atom, R₂ is the structure of Formula (1-4), and R₃ is a hydrogen atom. The phosphorus content of Copolymer CP2 is 7.0%, and the weight average molecular weight of Copolymer CP2 is about 19,100 as measured by GPC.

### Synthesis Example 3

Diphenyl(vinyl)phosphine oxide (CAS No: 2096-78-8, commercially available), 4-vinylbenzyl(triphenyl)phosphonium chloride, 0.5 wt % of 2,2′-azobis(2,4,4-trimethylpentane) relative to the total weight of the aforesaid raw materials and a solvent (such as DMAc) were added into a three-necked flask, and a solid content was about 30 wt %, wherein the molar ratio of diphenyl(vinyl)phosphine oxide to 4-vinylbenzyl(triphenyl)phosphonium chloride was 1.5:1.0. A mixture solution was obtained by stirring continuously, followed by heating from room temperature to 120° C. and stirring continuously for 16 hours. After purification, relative to the purified product, 9 wt % of formaldehyde, 2 wt % of potassium hydroxide and an appropriate amount of THF were added and reacted for 4 hours. The mixture solution was purified by methanol/water at a weight ratio of 7/3 to obtain Copolymer CP3, which is the vinyl group-containing phosphoric copolymer of the present disclosure. Copolymer CP3 includes the structural unit of Formula (1-1) and the structural unit of Formula (1-2), wherein R₁ is a hydrogen atom, R₂ is the structure of Formula (1-7) and r and q are both 0, and R₃ is a hydrogen atom. The phosphorus content of Copolymer CP3 is 9.9%, and the weight average molecular weight of Copolymer CP3 is about 18,900 as measured by GPC.

### Synthesis Example 4

Bis(3,5-dimethylphenyl) vinylbenzyl phosphine oxide (available from CHENG CI CORPORATION), 4-vinylbenzyl(triphenyl)phosphonium chloride, 0.5 wt % of 2,2′-azobis(2,4,4-trimethylpentane) relative to the total weight of the aforesaid raw materials and a solvent (such as DMAc) were added into a three-necked flask, and a solid content was about 30 wt %, wherein the molar ratio of bis(3,5-dimethylphenyl) vinylbenzyl phosphine oxide to 4-vinylbenzyl(triphenyl)phosphonium chloride was 9.0:1.0. A mixture solution was obtained by stirring continuously, followed by heating from room temperature to 120° C. and stirring continuously for 16 hours. After purification, relative to the purified product, 9 wt % of formaldehyde, 2 wt % of potassium hydroxide and an appropriate amount of THF were added and reacted for 4 hours. The mixture solution was purified by methanol/water at a weight ratio of 7/3 to obtain Copolymer CP4, which is the vinyl group-containing phosphoric copolymer of the present disclosure. Copolymer CP4 includes the structural unit of Formula (1-1) and the structural unit of Formula (1-2), wherein R₁ is a hydrogen atom, R₂ is the structure of Formula (1-3) and r and q are both 2, and R₃ is a hydrogen atom. The phosphorus content of Copolymer CP4 is 7.1%, and the weight average molecular weight of Copolymer CP4 is about 1,500 as measured by GPC.

### Synthesis Example 5

Substantially the same as Synthesis Example 1, except that the mixture solution was heated from room temperature to 140° C. and stirred continuously for 26 hours to obtain Copolymer CP5, which has the same structural units as Copolymer CP1 and is the vinyl group-containing phosphoric copolymer of the present disclosure. The phosphorus content of Copolymer CP5 is 7.0%, and the weight average molecular weight of Copolymer CP5 is about 49,900 as measured by GPC.

### Synthesis Example 6

A compound of Formula (4) (available from UFC Corp.), 4-vinylbenzyl(triphenyl)phosphonium chloride, 0.5 wt % of 2,2′-azobis(2,4,4-trimethylpentane) relative to the total weight of the aforesaid raw materials and a solvent (such as DMAc) were added into a three-necked flask, and a solid content was about 30 wt %, wherein the molar ratio of the compound of Formula (4) to 4-vinylbenzyl(triphenyl)phosphonium chloride was 5.0:1.0. A mixture solution was obtained by stirring continuously, followed by heating from room temperature to 120° C. and stirring continuously for 16 hours. After purification, relative to the purified product, 9 wt % of formaldehyde, 2 wt % of potassium hydroxide and an appropriate amount of THF were added and reacted for 4 hours. The mixture solution was purified by methanol/water at a weight ratio of 7/3 to obtain Copolymer CP6, which is the vinyl group-containing phosphoric copolymer of the present disclosure. Copolymer CP6 includes the structural unit of Formula (1-1) and the structural unit of Formula (1-2), wherein R₁ is methyl, R₂ is the structure of Formula (1-5) and r and q are both 0, and R₃ is a hydrogen atom. The phosphorus content of Copolymer CP6 is 9.5%, and the weight average molecular weight of Copolymer CP6 is about 18,900 as measured by GPC.

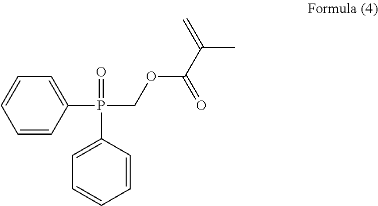

### Synthesis Example 7

A compound of Formula (5) (available from UFC Corp.), divinylbenzene, 0.5 wt % of AIBN relative to the total weight of the aforesaid materials and a solvent (such as DMAc) were added into a three-necked flask, and a solid content was about 30 wt %, wherein the molar ratio of the compound of Formula (5) to divinylbenzene was 1.0:1.0. A mixture solution was obtained by stirring continuously, followed by heating from room temperature to 70° C. and stirring continuously for 13 hours. The temperature was then raised to 110° C. and stirred continuously for 13 hours. After purification, Copolymer CP7 was obtained, which is the vinyl group-containing phosphoric copolymer of the present disclosure. Copolymer CP7 includes the structural unit of Formula (1-1) and the structural unit of Formula (1-2), wherein R₁ is methyl, R₂ is the structure of Formula (1-6), and R₃ is a hydrogen atom. The phosphorus content of Copolymer CP7 is 7.0%, and the weight average molecular weight of Copolymer CP7 is about 18,800 as measured by GPC.

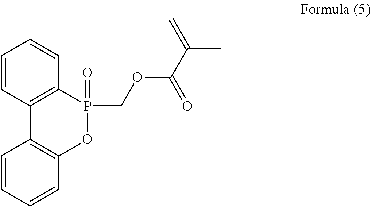

### Synthesis Example 8

Substantially the same as Synthesis Example 1, except that the molar ratio of p-vinylbenzyl-DPPO to 4-vinylbenzyl(triphenyl)phosphonium chloride is changed from 2.1:2.0 to 1.3:3.0 to obtain Copolymer CP8. Copolymer CP8 has the same structural units as Copolymer CP1. The phosphorus content of Copolymer CP8 is 5.0%, and the weight average molecular weight of Copolymer CP8 is about 18,900 as measured by GPC.

### Synthesis Example 9

Substantially the same as Synthesis Example 2, except that the molar ratio of p-vinylbenzyl-DOPO to divinylbenzene is changed from 1.2:1.0 to 1.0:2.0 to obtain Copolymer CP9. Copolymer CP9 has the same structural units as Copolymer CP2. The phosphorus content of Copolymer CP9 is 5.2%, and the weight average molecular weight of Copolymer CP9 is about 19,000 as measured by GPC.

### Synthesis Example 10

4.5 g of p-vinylbenzyl-DPPO, 0.0225 g of AIBN and a solvent (such as DMAc) were added into a three-necked flask, and a solid content was about 30 wt %. After stirring continuously and mixing well, the mixture solution was heated from room temperature to 120° C. and stirred continuously for 16 hours. After purification, Homopolymer CP10 was obtained, which includes the structural unit of Formula (1-1), wherein R₁ is a hydrogen atom, R₂ is the structure of Formula (1-3), and r and q are both 0. The phosphorus content of Homopolymer CP10 is 9.7%, and the weight average molecular weight of Homopolymer CP10 is about 18,700 as measured by GPC.

### Synthesis Example 11

10 g of divinylbenzene, 0.05 g of boron trifluoride and a solvent (such as toluene) were added into a three-necked flask, and a solid content was about 30 wt %. After stirring continuously and mixing well, the mixture solution was heated from room temperature to 90° C. and stirred continuously for 8 hours. After purification, Homopolymer CP11 was obtained, which includes the structural unit of Formula (1-2), wherein R₃ is a hydrogen atom. The phosphorus content of Homopolymer CP11 is 0%, and the weight average molecular weight of Homopolymer CP11 is about 18,600 as measured by GPC.

### Synthesis Example 12

p-Vinylbenzyl-DPPO, styrene, 0.5 wt % of AIBN relative to the total weight of the aforesaid raw materials and a solvent (such as DMAc) were added into a three-necked flask, and a solid content was about 30 wt %, wherein the molar ratio of p-vinylbenzyl-DPPO to styrene was 0.9:1.1. A mixture solution was obtained by stirring continuously and then heated from room temperature to 120° C., followed by stirring continuously for 16 hours. After purification, Copolymer CP12 was obtained, which includes the structural unit of Formula (1-1) and the structural unit of Formula (1-9), wherein R₁ is a hydrogen atom, R₂ is the structure of Formula (1-3), and r and q are both 0. The phosphorus content of Copolymer CP12 is 7.0%, and the weight average molecular weight of Copolymer CP12 is about 18,800 as measured by GPC.

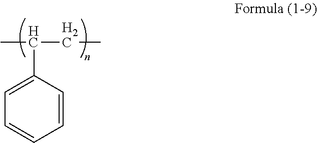

### Synthesis Example 13

Substantially the same as Synthesis Example 1, except that the mixture solution was heated from room temperature to 140° C. and continuously stirred for 36 hours to obtain Copolymer CP13, which has the same structural units as Copolymer CP1. The phosphorus content of Copolymer CP13 is 7.0%, and the weight average molecular weight of Copolymer CP13 is about 80,000 as measured by GPC.

### Synthesis Example 14

Substantially the same as Synthesis Example 1, except that the mixture solution was stirred for 1 hour to obtain Copolymer CP14, which has the same structural units as Copolymer CP1. The phosphorus content of Copolymer CP14 is 7.0%, and the weight average molecular weight of Copolymer CP14 is about 500 as measured by GPC.

### Synthesis Example 15

Vinyl-DOPO, divinylbenzene, 0.5 wt % of AIBN relative to the total weight of the aforesaid materials and a solvent (such as DMAc) were added a three-necked flask, and a solid content was about 30 wt %, wherein the molar ratio of vinyl-DOPO to divinylbenzene was 1.0:1.0. A mixture solution was obtained by stirring continuously, followed by heating from room temperature to 70° C. and stirring continuously for 13 hours. The temperature was then raised to 110° C. and stirred continuously for 13 hours. After purification, Copolymer CP15 was obtained, which is the vinyl group-containing phosphoric copolymer of the present disclosure. Copolymer CP15 includes the structural unit of Formula (1-1) and the structural unit of Formula (1-2), wherein R₁ is a hydrogen atom, R₂ is the structure of Formula (1-8), and R₃ is a hydrogen atom. The phosphorus content of Copolymer CP15 is 8.3%, and the weight average molecular weight of Copolymer CP15 is about 19,000 as measured by GPC.

### Synthesis Example 16

296 parts by weight of 2-bromoethylbenzene (manufactured by Tokyo Chemical Industry Co., Ltd.), 70 parts by weight of α,α′-dichloro-p-xylene (manufactured by Tokyo Chemical Industry Co., Ltd.) and 18.4 parts by weight of methanesulfonic acid (manufactured by Tokyo Chemical Industry Co., Ltd.) were reacted at 130° C. for 8 hours, followed by being cooled to room temperature, neutralized with aqueous sodium hydroxide solution, and extracted with 1,200 parts by weight of toluene. The organic layer was washed with water. The solvent and excess 2-bromoethylbenzene were removed by distillation under heating and reduced pressure to obtain the intermediate. The molar ratio of 2-bromoethylbenzene to α,α′-dichloro-p-xylene may be 4:1; methanesulfonic acid was used as an acidic catalyst and may be replaced by other acidic catalysts such as hydrochloric acid and phosphoric acid; and the reaction conditions may be 40 to 180° C. for 0.5 to 20 hours.

22 parts by weight of the aforesaid intermediate, 50 parts by weight of toluene (other aromatic solvents may also be used, such as xylene), 150 parts by weight of dimethyl sulfoxide (other aprotic polar solvents may also be used, such as dimethyl sulfone), 15 parts by weight of water and 5.4 parts by weight of sodium hydroxide (other alkaline catalysts may also be used, such as potassium hydroxide and potassium carbonate) were reacted at 40° C. for 5 hours, followed by being cooled to room temperature, and then added with 100 parts by weight of toluene. The organic layer was washed with water, and the solvent was removed by distillation under heating and reduced pressure to obtain the multi-functional aromatic vinyl group-containing compound, which has the structure of Formula (2).

### Synthesis Example 17

p-Vinylbenzyl-DPPO, N-(2,6-xylyl) maleimide (commercially available), 0.5 wt % of AIBN relative to the total weight of the aforesaid materials and a solvent (such as DMAc) were added into a three-necked flask, and a solid content was about 30 wt %, wherein the molar ratio of p-vinylbenzyl-DPPO to N-(2,6-xylyl) maleimide was 2.0:1.0. A mixture solution was obtained by stirring continuously and then heated from room temperature to 120° C., followed by stirring continuously for 16 hours. After purification, a second copolymer was obtained, which includes the structural unit of Formula (3-1) and the structural unit of Formula (3-2). The phosphorus content of the second copolymer is 7.4%, and the weight average molecular weight of the second copolymer is about 18,000 as measured by GPC.

Compositions (in part by weight) and test results of resin compositions of Examples and Comparative Examples are listed below, wherein the part by weight refers to the amount, in part by weight, of each component with a solid content of 100%. For example, Example E1 contains 55 parts by weight of Copolymer CP1, indicating the amount of Copolymer CP1, with a solid content of 100%, is 55 parts by weight. In addition, not all CP1 to CP15 are copolymers. For example, CP10 and CP11 are homopolymers. However, for the convenience of comparison, they are collectively called copolymers and are all listed under the column of first copolymer.

TABLE 1
Resin compositions of Examples (in part by weight) and test results

| Component | Name | E1 | E2 | E3 | E4 | E5 |
|---|---|---|---|---|---|---|
| first copolymer | CP1 | 55 | | | | |
| | CP2 | | 55 | | | |
| | CP3 | | | 55 | | |
| | CP4 | | | | 55 | |
| | CP5 | | | | | 55 |
| | CP6 | | | | | |
| | CP7 | | | | | |
| | CP8 | | | | | |
| | CP9 | | | | | |
| | CP10 | | | | | |
| | CP11 | | | | | |
| | CP12 | | | | | |
| | CP13 | | | | | |
| | CP14 | | | | | |
| | CP15 | | | | | |
| vinyl group-containing | SA9000 | 50 | 50 | 50 | 50 | 50 |
| polyphenylene ether resin | DPPE-VBT50 | 50 | 50 | 50 | 50 | 50 |
| additive | MIR-5000 | | | | | |
| | BMI-3000 | | | | | |
| | Ricon 100 | | | | | |
| | Ricon 257 | | | | | |
| | BVPE | | | | | |
| | ESTENAMER 8012 | | | | | |
| p-vinylbenzyl-DOPO | | | | | | |
| divinylbenzene | | | | | | |
| multi-functional aromatic | Formula (2) | | | | | |
| vinyl group-containing | | | | | | |
| compound | | | | | | |
| second copolymer | | | | | | |
| inorganic filler | SC2050 | 120 | 120 | 120 | 120 | 120 |
| initiator | azo compound | 0.5 | 0.5 | 0.5 | 0.5 | 0.5 |
| solvent | anisole | 100 | 100 | 100 | 100 | 100 |

| Property | Unit | E1 | E2 | E3 | E4 | E5 |
|---|---|---|---|---|---|---|
| dielectric constant | none | 3.31 | 3.32 | 3.15 | 3.12 | 3.21 |
| dissipation factor | none | 0.0025 | 0.0022 | 0.0023 | 0.0020 | 0.0023 |
| copper foil peeling strength | lb/in | 3.21 | 3.24 | 3.27 | 3.23 | 3.25 |
| flame retardancy | none | V-0 | V-0 | V-0 | V-0 | V-0 |
| glass transition temperature | ° C. | 193 | 195 | 191 | 192 | 195 |
| PCT water absorption ratio | % | 0.24 | 0.25 | 0.18 | 0.19 | 0.22 |

TABLE 2
Resin compositions of Examples (in part by weight) and test results

| Component | Name | E6 | E7 | E8 | E9 | E10 |
|---|---|---|---|---|---|---|
| first copolymer | CP1 | | | 60 | 80 | |
| | CP2 | | | | | |
| | CP3 | | | | | |
| | CP4 | | | | | |
| | CP5 | | | | | |
| | CP6 | 55 | | | | 55 |
| | CP7 | | 55 | | | |
| | CP8 | | | | | |
| | CP9 | | | | | |
| | CP10 | | | | | |
| | CP11 | | | | | |
| | CP12 | | | | | |
| | CP13 | | | | | |
| | CP14 | | | | | |
| | CP15 | | | | | |
| vinyl group-containing | SA9000 | 50 | 50 | 50 | 50 | 50 |
| polyphenylene ether resin | DPPE-VBT50 | 50 | 50 | 50 | 50 | 50 |
| additive | MIR-5000 | | | | | |
| | BMI-3000 | | | | | |
| | Ricon 100 | | | | | |
| | Ricon 257 | | | | | |
| | BVPE | | | | | |
| | ESTENAMER 8012 | | | | | |
| p-vinylbenzyl-DOPO | | | | | | |
| divinylbenzene | | | | | | |
| multi-functional aromatic | Formula (2) | | | | | 13 |
| vinyl group-containing | | | | | | |
| compound | | | | | | |
| second copolymer | | | | | | |
| inorganic filler | SC2050 | 120 | 120 | 120 | 120 | 120 |
| initiator | azo compound | 0.5 | 0.5 | 0.5 | 0.5 | 0.5 |
| solvent | anisole | 100 | 100 | 100 | 100 | 100 |

| Property | Unit | E6 | E7 | E8 | E9 | E10 |
|---|---|---|---|---|---|---|
| dielectric constant | none | 3.23 | 3.18 | 3.33 | 3.32 | 3.07 |
| dissipation factor | none | 0.0025 | 0.0023 | 0.0025 | 0.0026 | 0.0019 |
| copper foil peeling strength | lb/in | 3.24 | 3.27 | 3.24 | 3.26 | 3.29 |
| flame retardancy | none | V-0 | V-0 | V-0 | V-0 | V-0 |
| glass transition temperature | ° C. | 194 | 196 | 191 | 190 | 209 |
| PCT water absorption ratio | % | 0.27 | 0.28 | 0.25 | 0.28 | 0.20 |

TABLE 3
Resin compositions of Examples (in part by weight) and test results

| Component | Name | E11 | E12 | E13 | E14 | E15 | E16 |
|---|---|---|---|---|---|---|---|
| first copolymer | CP1 | | | | 10 | 12 | |
| | CP2 | | | | 5 | 5 | |
| | CP3 | | | | 10 | 24 | |
| | CP4 | | 55 | 55 | 10 | 6 | |
| | CP5 | | | | 15 | 8 | |
| | CP6 | 55 | | | 10 | 15 | |
| | CP7 | | | | 15 | 5 | |
| | CP8 | | | | | | |
| | CP9 | | | | | | |
| | CP10 | | | | | | |
| | CP11 | | | | | | |
| | CP12 | | | | | | |
| | CP13 | | | | | | |
| | CP14 | | | | | | |
| | CP15 | | | | | | 55 |
| vinyl group-containing | SA9000 | 50 | 50 | 50 | 80 | 40 | 50 |
| polyphenylene ether resin | DPPE-VBT50 | 50 | 50 | 50 | 20 | 60 | 50 |
| additive | MIR-5000 | | | | 4 | 18 | |
| | BMI-3000 | | | | 3 | 8 | |
| | Ricon 100 | | | | 3 | 7 | |
| | Ricon 257 | | | | 5 | 7 | |
| | BVPE | | | | 5 | 10 | |
| | ESTENAMER | | | | 5 | 15 | |
| | 8012 | | | | | | |
| p-vinylbenzyl-DOPO | | | | | | | |
| divinylbenzene | | | | | | | |
| multi-functional aromatic | Formula (2) | 25 | | | 5 | 10 | |
| vinyl group-containing | | | | | | | |
| compound | | | | | | | |
| second copolymer | | | 5 | 10 | | | |
| inorganic filler | SC2050 | 120 | 120 | 120 | 100 | 150 | 120 |
| initiator | azo compound | 0.5 | 0.5 | 0.5 | 0.2 | 0.8 | 0.5 |
| solvent | anisole | 100 | 100 | 100 | 80 | 120 | 100 |

| Property | Unit | E11 | E12 | E13 | E14 | E15 | E16 |
|---|---|---|---|---|---|---|---|
| dielectric constant | none | 3.04 | 3.03 | 3.01 | 3.05 | 3.01 | 3.02 |
| dissipation factor | none | 0.0017 | 0.0021 | 0.0023 | 0.0015 | 0.0013 | 0.0015 |
| copper foil peeling strength | lb/in | 3.26 | 3.46 | 3.44 | 3.31 | 3.27 | 3.25 |
| flame retardancy | none | V-0 | V-0 | V-0 | V-0 | V-0 | V-0 |
| glass transition temperature | ° C. | 203 | 213 | 219 | 206 | 202 | 200 |
| PCT water absorption ratio | % | 0.19 | 0.25 | 0.28 | 0.18 | 0.16 | 0.19 |

TABLE 4
Resin compositions of Comparative Examples (in part by weight) and test results

| Component | Name | C1 | C2 | C3 | C4 | C5 |
|---|---|---|---|---|---|---|
| first copolymer | CP1 | | | | | |
| | CP2 | | | | | |
| | CP3 | | | | | |
| | CP4 | | | | | |
| | CP5 | | | | | |
| | CP6 | | | | | |
| | CP7 | | | | | |
| | CP8 | 55 | | | | |
| | CP9 | | 55 | | | |
| | CP10 | | | 55 | | |
| | CP11 | | | | 55 | |
| | CP12 | | | | | 55 |
| | CP13 | | | | | |
| | CP14 | | | | | |
| | CP15 | | | | | |
| vinyl group-containing | SA9000 | 50 | 50 | 50 | 50 | 50 |
| polyphenylene ether resin | DPPE-VBT50 | 50 | 50 | 50 | 50 | 50 |
| additive | MIR-5000 | | | | | |
| | BMI-3000 | | | | | |
| | Ricon 100 | | | | | |
| | Ricon 257 | | | | | |
| | BVPE | | | | | |
| | ESTENAMER 8012 | | | | | |
| p-vinylbenzyl-DOPO | | | | | | |
| divinylbenzene | | | | | | |
| multi-functional aromatic | Formula (2) | | | | | |
| vinyl group-containing | | | | | | |
| compound | | | | | | |
| second copolymer | | | | | | |
| inorganic filler | SC2050 | 120 | 120 | 120 | 120 | 120 |
| initiator | azo compound | 0.5 | 0.5 | 0.5 | 0.5 | 0.5 |
| solvent | anisole | 100 | 100 | 100 | 100 | 100 |

| Property | Unit | C1 | C2 | C3 | C4 | C5 |
|---|---|---|---|---|---|---|
| dielectric constant | none | 3.32 | 3.55 | 3.34 | 3.10 | 3.11 |
| dissipation factor | none | 0.0022 | 0.0043 | 0.0031 | 0.0021 | 0.0022 |
| copper foil peeling strength | lb/in | 3.11 | 3.22 | 3.15 | 2.15 | 2.85 |
| flame retardancy | none | V-2 | V-2 | V-0 | Burn | V-0 |
| glass transition temperature | ° C. | 132 | 116 | 118 | 90 | 117 |
| PCT water absorption ratio | % | 0.31 | 0.31 | 0.33 | 0.35 | 0.37 |

TABLE 5
Resin compositions of Comparative Examples (in part by weight) and test results

| Component | Name | C6 | C7 | C8 |
|---|---|---|---|---|
| first copolymer | CP1 | | | |
| | CP2 | | | |
| | CP3 | | | |
| | CP4 | | | |
| | CP5 | | | |
| | CP6 | | | |
| | CP7 | | | |
| | CP8 | | | |
| | CP9 | | | |
| | CP10 | | | |
| | CP11 | | | |
| | CP12 | | | |
| | CP13 | | 55 | |
| | CP14 | | | 55 |
| | CP15 | | | |
| vinyl group-containing | SA9000 | 50 | 50 | 50 |
| polyphenylene ether resin | DPPE-VBT50 | 50 | 50 | 50 |
| additive | MIR-5000 | | | |
| | BMI-3000 | | | |
| | Ricon 100 | | | |
| | Ricon 257 | | | |
| | BVPE | | | |
| | ESTENAMER 8012 | | | |
| p-vinylbenzyl-DOPO | | 50 | | |
| divinylbenzene | | 5 | | |
| multi-functional aromatic vinyl | Formula (2) | | | |
| group-containing compound | | | | |
| second copolymer | | | | |
| inorganic filler | SC2050 | 120 | 120 | 120 |
| initiator | azo compound | 0.5 | 0.5 | 0.5 |
| solvent | anisole | 100 | 100 | 100 |

| Property | Unit | C6 | C7 | C8 |
|---|---|---|---|---|
| dielectric constant | none | 3.05 | failed to be | 3.35 |
| dissipation factor | none | 0.0038 | formed | 0.0037 |
| copper foil peeling strength | lb/in | 2.67 | | 2.97 |
| flame retardancy | none | V-2 | | V-1 |
| glass transition temperature | ° C. | 105 | | 157 |
| PCT water absorption ratio | % | 0.40 | | 0.42 |

On the other hand, for the products CP1 to CP15 obtained in Synthesis Example 1 to Synthesis Example 15, the following methods can be used to measure or evaluate their dissipation factor and solvent compatibility, respectively.

Dissipation factor: any one of CP1 to CP15 and a solvent (DMAc) were individually added to a stirred tank and well-mixed to form a varnish. Then the varnish was loaded to an impregnation tank, and a fiberglass fabric (e.g., 1078 L-glass fiber fabric, available from Asahi) was impregnated into the impregnation tank to adhere each copolymer onto the fiberglass fabric, followed by heating at 100° C. to 140° C. to the semi-cured state (B-stage) to obtain a prepreg, having a resin content of about 70%. Two 0.5 oz hyper very low profile (HVLP) copper foils and two prepregs described above were prepared and stacked in the order of one copper foil, two prepregs and one copper foil, followed by lamination under vacuum condition with a lamination pressure of 250 psi to 600 psi at 200° C. to 220° C. for 90 minutes to 120 minutes so as to obtain a copper-containing laminate. Each copper-containing laminate obtained above was etched to remove copper foils on both sides so as to obtain the copper-free laminate. The copper-free laminate sample was measured by using a microwave dielectrometer (available from AET Corp.) by reference to JIS C2565 at room temperature (about 25° C.) and under 10 GHz frequency to obtain the dissipation factor.

Solvent compatibility: any one of CP1 to CP15 and a solvent mixture (methyl ethyl ketone/toluene) were placed in a transparent glass bottle at a weight ratio of 1:5, stirred evenly, and stood still at room temperature (about 25° C.) for 24 hours, followed by visual inspection with naked eyes to determine whether precipitation occurs. If a precipitate was generated, a designation of “incompatible” was given, representing poor solvent compatibility; on the contrary, if there was no precipitate, a designation of “compatible” was given, representing good solvent compatibility.

Test results of dissipation factor and solvent compatibility are listed in Table 6 below.

TABLE 6
Test results of dissipation factor and solvent compatibility

| | dissipation | compatibility |
|---|---|---|
| Copolymer | factor | (MEK/toluene) |
| CP1 | 0.0025 | compatible |
| CP2 | 0.0024 | compatible |
| CP3 | 0.0022 | compatible |
| CP4 | 0.0025 | compatible |
| CP5 | 0.0024 | compatible |
| CP6 | 0.0022 | compatible |
| CP7 | 0.0023 | compatible |
| CP8 | 0.0027 | compatible |
| CP9 | 0.0029 | compatible |
| CP10 | 0.0031 | incompatible |
| CP11 | 0.0021 | incompatible |
| CP12 | 0.0020 | incompatible |
| CP13 | 0.0023 | incompatible |
| CP14 | 0.0038 | compatible |
| CP15 | 0.0025 | compatible |

It can be observed from Table 6 that the vinyl group-containing phosphoric copolymer of the present disclosure (such as CP1 to CP7 and CP15) or an article made therefrom has a dissipation factor as measured by reference to JIS C2565 at 10 GHz of less than or equal to 0.0025 and has good solvent compatibility. On the other hand, other polymers (such as CP8 to CP14) cannot meet the above good properties at the same time.

In addition, for the resin compositions of Examples and Comparative Examples, various properties listed in Tables 1 to 5 can be measured. Samples (specimens) for the properties measured above were prepared as described below and tested and analyzed under specified conditions below.

### 1. Prepreg (PP)

Resin composition (in part by weight) from each Example or each Comparative Example was separately added to a stirred tank and well-mixed to form a varnish. The varnish was loaded to an impregnation tank, and a fiberglass fabric (e.g., 1078 L-glass fiber fabric, available from Asahi) was impregnated into the impregnation tank to adhere the resin composition onto the fiberglass fabric, followed by heating at 100° C. to 140° C. to the semi-cured state (B-stage) to obtain a prepreg, having a resin content of about 70%.

### 2. Copper-Containing Laminate 1 (Obtained by Laminating Two Prepregs)

Two 0.5 oz hyper very low profile (HVLP) copper foils and two prepregs obtained from 1078 L-glass fiber fabrics impregnated with each Example or Comparative Example were prepared, each prepreg having a resin content of about 70%. A copper foil, two prepregs and a copper foil were superimposed in such order and then subjected to a vacuum condition for lamination at 250 psi to 600 psi and 200° C. to 220° C. for 90 minutes to 120 minutes to form each copper-containing laminate 1. The two prepregs were cured to form an insulation layer between the two copper foils, and the insulation layer has a resin content of about 70%.

### 3. Copper-Containing Laminate 2 (Obtained by Laminating Six Prepregs)

The preparation processes were substantially the same as those described in the copper-containing laminate 1, except that the insulation layer was made from six prepregs.

### 4. Copper-Containing Laminate 3 (Obtained by Laminating Eight Prepregs)

The preparation processes were substantially the same as those described in the copper-containing laminate 1, except that the insulation layer was made from eight prepregs.

### 5. Copper-Containing Laminate 4 (Obtained by Laminating Twelve Prepregs)

The preparation processes were substantially the same as those described in the copper-containing laminate 1, except that the insulation layer was made from twelve prepregs.

### 6. Copper-Free Laminate 1 (Obtained by Laminating Two Prepregs)

Each copper-containing laminate 1 made by laminating two prepregs obtained above was etched to remove the copper foils on both sides so as to obtain the copper-free laminate 1 (obtained by laminating two prepregs).

### 7. Copper-Free Laminate 2 (Obtained by Laminating Eight Prepregs)

Each copper-containing laminate 3 made by laminating eight prepregs obtained above was etched to remove the copper foils on both sides so as to obtain the copper-free laminate 2 (obtained by laminating eight prepregs).

### 8. Copper-Free Laminate 3 (Obtained by Laminating Twelve Prepregs)

Each copper-containing laminate 4 made by laminating twelve prepregs obtained above was etched to remove the copper foils on both sides so as to obtain the copper-free laminate 3 (obtained by laminating twelve prepregs).

For each sample, test items and test methods are described below.

### Dielectric Constant (Dk)

The aforesaid copper-free laminate 1 (obtained by laminating two prepregs, resin content of about 70%) was subjected to dielectric constant measurement. Each specimen was measured by using a microwave dielectrometer (available from AET Corp.) by reference to JIS C2565 at room temperature (about 25° C.) and under 10 GHz frequency so as to obtain the dielectric constant. Lower dielectric constant represents better dielectric properties of the sample. Under a 10 GHz frequency, for a low Dk material, a difference in Dk of less than 0.10 represents no substantial difference (i.e., no significant technical difficulty) in dielectric constant in different laminates, and a difference in Dk of greater than or equal to 0.10 represents a substantial difference (i.e., significant technical difficulty) in dielectric constant in different laminates.

### Dissipation Factor (Df)

The aforesaid copper-free laminate 1 (obtained by laminating two prepregs, having a resin content of about 70%) was subject to dissipation factor measurement. Each specimen was measured by using a microwave dielectrometer (available from AET Corp.) by reference to JIS C2565 at room temperature (about 25° C.) and under 10 GHz frequency to obtain the dissipation factor. Under a 10 GHz frequency, for a Df value of between 0.0010 and 0.0030, a difference in Df of less than 0.0010 represents no substantial difference (i.e., no significant technical difficulty) in dissipation factor of laminates, and a difference in Df of greater than or equal to 0.0010 represents a substantial difference (i.e., significant technical difficulty) in dissipation factor in different laminates.

Copper foil peeling strength (0.5 oz peeling strength, 0.5 oz P/S)

A copper-containing laminate 2 (obtained by laminating six prepregs) was cut into a rectangular sample with a width of 24 mm and a length of 80 mm, which was etched to remove surface copper foil to leave a rectangular copper foil with a width of 3.18 mm and a length of greater than 60 mm, and tested by using a tensile strength tester by reference to IPC-TM-650 2.4.8 at room temperature (about 25° C.) to measure the 0.5-ounce (half-ounce) copper foil peeling strength (0.5 oz P/S, in lb/in). In the technical field to which the present disclosure pertains, higher copper foil peeling strength is better.

Flame Retardancy (a.k.a. Flame Resistance)

A copper-free laminate 2 (obtained by laminating eight prepregs) sample was prepared and subjected to the measurement. The flame retardancy test was performed in accordance with the UL94 rating, and the results were represented by V-0, V-1, or V-2, wherein V-O indicates a superior flame retardancy to V-1, V-1 indicates a superior flame retardancy to V-2, and burnout of sample is the worst.

### Glass Transition Temperature (Tg)

A copper-free laminate 3 (obtained by laminating twelve prepregs) sample was prepared and subjected to dynamic mechanical analysis (DMA). The sample was heated from 35° C. to 380° C. at a heating rate of 2° C./minute and then subjected to the measurement of glass transition temperature (° C.) by reference to the method described in IPC-TM-650 2.4.24.4. Higher glass transition temperature represents a better property of the sample.

### Pressure Cooking Test (PCT) Water Absorption Ratio

A 2 inch×2 inch copper-free laminate 1 (obtained by laminating two prepregs) sample was placed in a 105±10° C. oven and baked for 1 hour, then cooled at room temperature of about 25° C. for 10 minutes and weighed to give a weight value W1 representing the weight of the copper-free laminate; then the sample was subjected to a pressure cooking test (PCT) by reference to IPC-TM-650 2.6.16.1 for 5 hours of moisture absorption (test temperature of 121° C. and relative humidity of 100%) and wiped to remove residual water on the surface; the sample was weighed again to give a weight value W2 representing the weight of the copper-free laminate after water absorption. The PCT water absorption ratio (%) was calculated as follows: water absorption ratio (%)=[(W2−W1)/W1]×100%. Lower PCT water absorption ratio represents a better property of the sample.

The following observations can be made from Table 1 to Table 5.

In contrast with the resin composition containing the vinyl group-containing phosphoric copolymer of the present disclosure (Examples E1-E16), Comparative Examples C1-C8 using other polymers or monomers fail to achieve satisfactory results in at least one property including dielectric constant, dissipation factor, copper foil peeling strength, flame retardancy, glass transition temperature and PCT water absorption ratio.

In contrast with Comparative Examples C1 to C8, Examples E1 to E16 using the vinyl group-containing phosphoric copolymer of the present disclosure can achieve at the same time a better dielectric constant (a dielectric constant at 10 GHz as measured by reference to JIS C2565 of less than or equal to 3.33), a lower dissipation factor (a dissipation factor at 10 GHz as measured by reference to JIS C2565 of less than or equal to 0.0026), a higher copper foil peeling strength (a copper foil peeling strength as measured by reference to IPC-TM-650 2.4.8 of greater than or equal to 3.21 lb/in), a better flame retardancy (a flame retardancy of V-0 rating as measured by reference to UL94 standard), a better glass transition temperature (a glass transition temperature as measured by reference to IPC-TM-650 2.4.24.4 of greater than or equal to 190° C.) and a better PCT water absorption ratio (a water absorption ratio after 5 hours of moisture absorption in a pressure cooking test as measured by reference to IPC-TM-650 2.6.16.1 of less than or equal to 0.28%).

In addition, from the observation of the test results of Examples E10 to E15, it can be found that if the resin composition further comprises a multi-functional aromatic vinyl group-containing compound or the second copolymer disclosed herein, further improvements can be achieved in at least one or more of the aforementioned properties, such as but not limited to glass transition temperature.

The above detailed description is merely illustrative in nature and is not intended to limit the embodiments of the subject matter or the application and use of such embodiments. As used herein, the term “exemplary” means “serving as an example, instance, or illustration.” Any implementation described herein as exemplary is not necessarily to be construed as preferred or advantageous over other implementations.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description will provide those skilled in the art with a convenient guide for implementing the described one or more embodiments. Also, various changes can be made in the function and arrangement of elements without departing from the scope defined by the claims, which include known equivalents and foreseeable equivalents at the time of filing this patent application.

What is claimed is:

1. A vinyl group-containing phosphoric copolymer, which comprises a structural unit of Formula (1-1) and a structural unit of Formula (1-2), 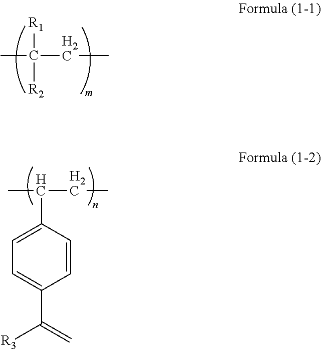
wherein:
m and n independently represent a repeating number of unit in the brackets by which the vinyl group-containing phosphoric copolymer has a weight average molecular weight of between 1,000 and 50,000;
R₁ and R₃ are independently a hydrogen atom or a C1 to C3 alkyl group; and
R₂ is a monovalent functional group selected from a group consisting of Formula (1-3) to Formula (1-8), wherein r and q are independently an integer of 0 to 3; 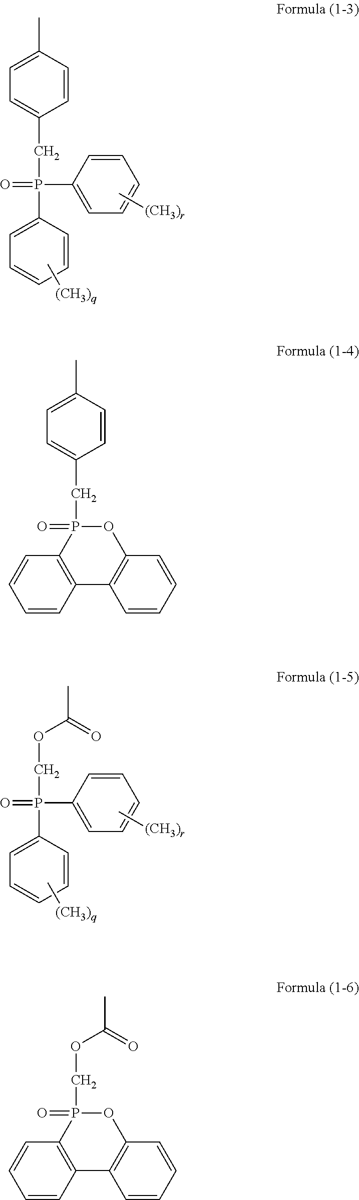 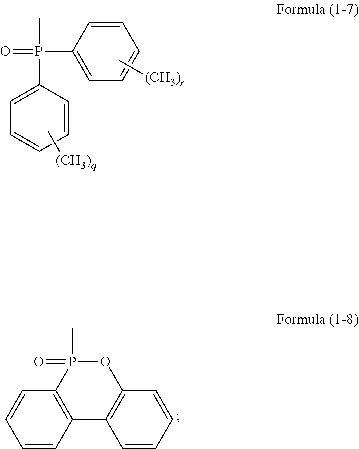
and the vinyl group-containing phosphoric copolymer has a phosphorus content of greater than or equal to 7%.

2. A resin composition, comprising 100 parts by weight of a vinyl group-containing polyphenylene ether resin and 55 to 80 parts by weight of the vinyl group-containing phosphoric copolymer of claim 1.

3. The resin composition of claim 2, further comprising a multi-functional aromatic vinyl group-containing compound.

4. The resin composition of claim 3, comprising 5 to 25 parts by weight of the multi-functional aromatic vinyl group-containing compound.

5. The resin composition of claim 3, wherein the multi-functional aromatic vinyl group-containing compound has the structure of Formula (2) below: 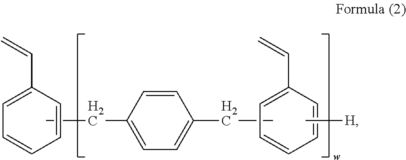
wherein w is between 1 and 20.

6. The resin composition of claim 2, wherein the vinyl group-containing phosphoric copolymer is a first copolymer, and the resin composition further comprises a second copolymer which comprises a structural unit of Formula (3-1) and a structural unit of Formula (3-2), 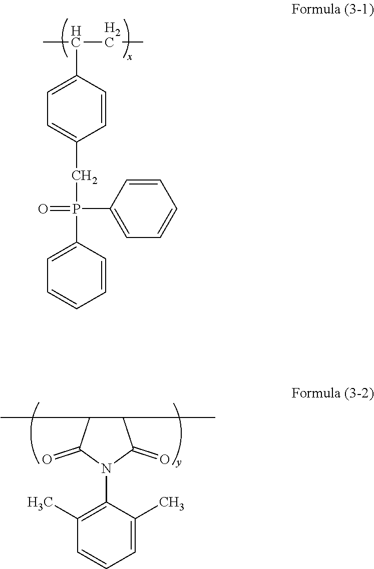
wherein x and y independently represent a repeating number of unit in the brackets by which the second copolymer has a weight average molecular weight of between 1,000 and 30,000; and
the second copolymer has a phosphorus content of greater than or equal to 7%.

7. The resin composition of claim 6, comprising 5 to 10 parts by weight of the second copolymer.

8. The resin composition of claim 2, further comprising inorganic filler, curing accelerator, flame retardant, polymerization inhibitor, solvent, silane coupling agent, coloring agent, toughening agent or a combination thereof.

9. An article made from the resin composition of claim 2, comprising a prepreg, a resin film, a laminate or a printed circuit board.

10. The article of claim 9, having a dielectric constant as measured by reference to JIS C2565 at 10 GHz of less than or equal to 3.33.

11. The article of claim 9, having a dissipation factor as measured by reference to JIS C2565 at 10 GHz of less than or equal to 0.0026.

12. The article of claim 9, having a copper foil peeling strength as measured by reference to IPC-TM-650 2.4.8 of greater than or equal to 3.21 lb/in.

13. The article of claim 9, having a flame retardancy of V-0 rating as measured by reference to UL94 standard.

14. The article of claim 9, having a glass transition temperature as measured by reference to IPC-TM-650 2.4.24.4 of greater than or equal to 190° C.

15. The article of claim 9, having a water absorption ratio after 5 hours of moisture absorption in a pressure cooking test as measured by reference to IPC-TM-650 2.6.16.1 of less than or equal to 0.28%.
